(19) United States
(12) Patent Application Publication
(10) Pub. No.: US 2024/0402992 A1
(43) Pub. Date: Dec. 5, 2024

(54) ELECTRONIC COMPUTER

(71) Applicant: Nippon Telegraph and Telephone Corporation, Tokyo (JP)

(72) Inventors: Naoki Miura, Tokyo (JP); Yuki Arikawa, Tokyo (JP); Takeshi Sakamoto, Tokyo (JP); Yusuke Muranaka, Tokyo (JP); Sampath Priyankara, Tokyo (JP); Teruaki Ishizaki, Tokyo (JP); Tsuyoshi Ito, Tokyo (JP); Kenji Tanaka, Tokyo (JP)

(21) Appl. No.: 18/699,200

(22) PCT Filed: Nov. 12, 2021
(86) PCT No.: PCT/JP2021/041751

§ 371 Date: Apr. 5, 2024

(51) Int. Cl. G06F 7/48

(52) U.S. Cl. CPC G06F 7/48

(57) ABSTRACT

An embodiment is an electronic computer including a plurality of arithmetic circuits which sequentially execute a plurality of processings on a processing data, and a controller which executes a program and performs a control of causing the plurality of arithmetic circuits to sequentially execute the plurality of processings. An arithmetic circuit ID is imparted to each of the plurality of arithmetic circuits, the plurality of arithmetic circuits include a first arithmetic circuit that executes a first processing among the plurality of processings, and a second arithmetic circuit that executes a second processing that executes processing on a processing result of the first processing among the plurality of processings, and the first arithmetic circuit transmits the processing result of the first processing to the arithmetic circuit ID of the second arithmetic circuit as a destination.

### CROSS-REFERENCE TO RELATED APPLICATIONS

This patent application is a national phase filing under section 371 of PCT/JP2021/041751, filed Nov. 12, 2021, which is incorporated herein by reference in its entirety.

### TECHNICAL FIELD

The present invention relates to an electronic computer.

### BACKGROUND

Devices such as a smartphone, a personal computer, and a server are constituted by an electronic computer. For example, such an electronic computer is configured to include a general-purpose processor for reading out a program and executing an operation, and a communication line such as a bus for connecting a storage device and the general-purpose processor. Various performance improvements such as higher speed, higher throughput, smaller size, lower power efficiency, improved processing flexibility, and improved user convenience are continuously required for the electronic computer. In order to meet the demand, arithmetic units having various features have been developed. For example, there are a GPU in which video and AI processing is fast, an ASIC in which only a specific function can be processed at ultra-high speed but the processing content cannot be changed, an FPGA which is fast but in which the processing content can be changed after manufacturing, and the like.

In recent years, a configuration that aims to improve the overall performance of an electronic computer by utilizing arithmetic unit units having various features as accelerators has been developed (NPL 1). In such a configuration, a control unit such as a general-purpose processor, a storage unit, a plurality of arithmetic parts such as FPGA, and a communication line such as a bus for connecting them are provided. In such a configuration, for specific processing, an arithmetic part which is good at the processing may take charge of the execution of the processing. Thus, the entire performance of the electronic computer is improved by allocating the processing to the arithmetic part which is good at the specific processing.

### CITATION LIST

### Non Patent Literature

[NPL 1] R. Takano and T. Kudoh, “Flow-centric computing leveraged by photonic circuit switching for the post-moore era,” 2016 Tenth IEEE/ACM International Symposium on Networks-on-Chip (NOCS), 2016, pp. 1-3, doi: 10.1109/NOCS.2016.7579339.

### SUMMARY

### Technical Problem

However, in the above configuration, the data transfer to the arithmetic part by a control unit becomes a bottleneck, and the throughput may not be improved.

An object of the present invention is to improve throughput in an electronic computer.

### Solution to Problem

In order to solve the above problem, an electronic computer of embodiments of the present invention includes a plurality of arithmetic circuits which sequentially execute a plurality of processings on processing data; and a control unit which executes a program and performs control of causing the plurality of arithmetic circuits to sequentially execute the plurality of processings, in which an arithmetic circuit ID is imparted to each of the plurality of arithmetic circuits, the plurality of arithmetic circuits include a first arithmetic circuit that executes a first processing among the plurality of processings, and a second arithmetic circuit that executes a second process that executes processing on a processing result of the first processing among the plurality of processings, and the first arithmetic circuit transmits the processing result of the first processing to the arithmetic circuit ID of the second arithmetic circuit as a destination.

### Advantageous Effects of Invention

According to the present invention, throughput in the electronic computer is improved.

### BRIEF DESCRIPTION OF THE DRAWINGS

FIG. 1 is a block diagram showing a configuration of an electronic computer according to a first embodiment of the present invention.

FIG. 2 is a flowchart of the operation of the electronic computer of FIG. 1.

FIG. 3 is a diagram showing a configuration example of a transmission circuit.

FIG. 4 is a block diagram showing the configuration of an electronic computer according to a modified example of the first embodiment.

FIG. 5 is a flowchart of the operation of an electronic computer according to a second embodiment.

FIG. 6 is a diagram showing a configuration example of an arithmetic circuit according to the second embodiment.

FIG. 7 is a diagram showing a configuration example of another arithmetic circuit according to the second embodiment.

FIG. 8 is a flowchart of an operation of an electronic computer according to a third embodiment.

FIG. 9 is a diagram showing a configuration example of an arithmetic circuit according to the third embodiment.

FIG. 10 is a diagram showing a data structure of data with an ID according to a fourth embodiment.

FIG. 11 is a diagram showing a configuration example of an ID conversion table according to a fifth embodiment.

FIG. 12 is a diagram showing a configuration example of an ID conversion table according to the fifth embodiment.

FIG. 13 is a flowchart of the operation of the electronic computer according to the fifth embodiment.

FIG. 14 is a diagram showing a configuration example of an arithmetic circuit according to the fifth embodiment.

FIG. 15 is a diagram showing a configuration example of an arithmetic circuit according to a sixth embodiment.

FIG. 16 is a block diagram showing a configuration of an electronic computer according to a seventh embodiment.

FIG. 17 is a block diagram showing a configuration of an electronic computer according to an eighth embodiment.

FIG. 18 is a diagram showing a data structure of Data with an ID according to the eighth embodiment.

FIG. 19 is a diagram showing a configuration example of a process setting table according to the eighth embodiment.

FIG. 20 is a flowchart of processing performed by an arithmetic circuit according to the eighth embodiment.

FIG. 21 is a configuration diagram of a data generating device according to the eighth embodiment.

FIG. 22 is a configuration diagram of the data generating device according to the eighth embodiment.

FIG. 23 is a diagram showing an aspect of generation of a processing setting table according to the eighth embodiment.

### DETAILED DESCRIPTION OF ILLUSTRATIVE EMBODIMENTS

Embodiments of the present invention will be described below with reference to the drawings, but the present invention is not limited to the following embodiments.

### First Embodiment

In the first embodiment of the present invention, by enabling direct transmission and reception of data between a plurality of arithmetic parts, the number of data transfers by the control unit is reduced and the throughput of the entire computer is improved.

### (Configuration of Electronic Computer 10)

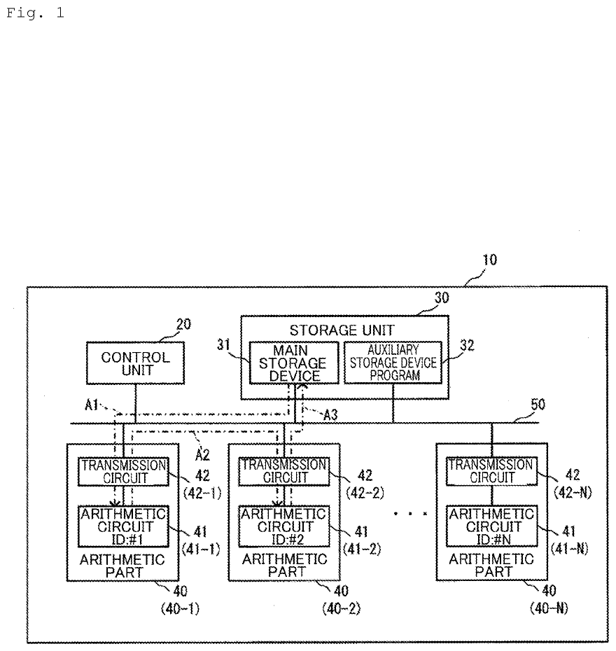

As shown in FIG. 1, an electronic computer 10 according to the first embodiment includes a control unit 20, a storage unit 30 including a main storage device 31 (main memory) and an auxiliary storage device 32 of the control unit 20, a plurality of arithmetic parts 40, and a communication line 50 such as a bus to which these are connected.

The control unit 20 reads a program stored in the auxiliary storage device 32 such as a hard disk or solid state drive (SSD) into the main storage device 31 such as a random access memory (RAM), and executes the program. The control unit 20 includes, for example, a processor for performing predetermined processing by executing a program, for example, a general-purpose processor such as a central processing unit (CPU). As will be described later, the control unit 20 executes a program for causing at least a part of the plurality of arithmetic parts 40 to perform processing.

Each arithmetic part 40 is made up of one-chip integrated circuit such as a field-Programmable Gate Array (FPGA) and an application specific integrated circuit (ASIC). Each arithmetic part 40 includes an arithmetic circuit 41 and a transmission circuit 42.

The arithmetic circuit 41 is configured to execute predetermined processing. The types of processing executed by the respective arithmetic circuits 41 are different from each other. In the arithmetic circuit 41, “#1” to “#N” are set as an arithmetic circuit ID capable of uniquely identifying each arithmetic circuit 41. Hereinafter, when the arithmetic circuit 41 is discriminated for each arithmetic circuit ID, each arithmetic circuit 41 may be referred to as arithmetic circuits 41-1 to 41-N, respectively. For example, the arithmetic circuit 41 to which “#1” is imparted is also referred to as an arithmetic circuit 41-1. The arithmetic circuit 41 to which “#2” is imparted is also referred to as an arithmetic circuit 41-2. The arithmetic circuit 41 to which “#N” is imparted is also referred to as an arithmetic circuit 41-N. The arithmetic parts 40 having respective arithmetic circuits 41-1 to 41-N are sometimes referred to as arithmetic parts 40-1 to 40-N.

The transmission circuit 42 transmits data transmitted from the control unit 20, the main storage device 31 or the other arithmetic part 40 via the communication line 50 to the arithmetic circuit 41. Further, the transmission circuit 42 transmits the data output by the arithmetic circuit 41 of the same arithmetic part 40 to the control unit 20, the main storage device 31 or the other arithmetic part 40 via the communication line 50. Each transmission circuit 42 of the arithmetic parts 40-1 to 40-N is called transmission circuits 42-1 to 42-N, respectively.

### (Operation Example of Electronic Computer 10)

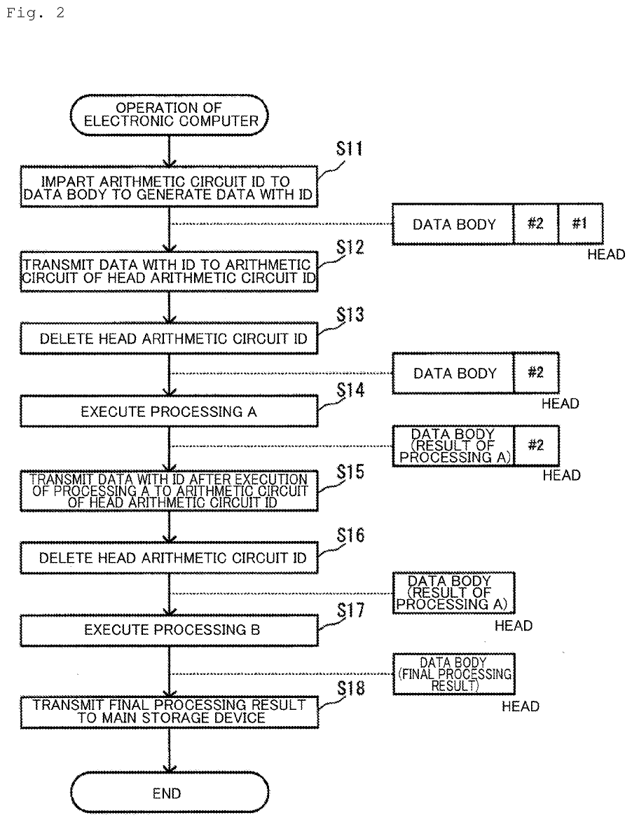

An example of the operation of the electronic computer 10 will be described with reference to FIGS. 1 and 2. Here, as an example, the electronic computer 10 executes processing A and processing B, using the calculation result of the processing A. The processing A is executed by an arithmetic circuit 41-1. The processing B is executed by an arithmetic circuit 41-2. Examples of the processing A and the processing B include image processing. As an example of the processing A, there is a binarization processing of an image, and as an example of the processing B, there is an edge detection processing for a binarized image. It is also assumed that the main storage device 31 of the storage unit 30 stores processing data to be processed of the processing A and processing B supplied from the outside via, for example, a network.

When the control unit 20 reads out the program which is stored in the auxiliary storage device 32 and designates execution of the processing A and the processing B to the main storage device 31 and starts the execution, the operation shown in FIG. 2 is started. Hereinafter, the control unit 20 executes the above-mentioned program to perform the following operation.

In the operation shown in FIG. 2, first, the control unit 20 sets the processing data stored in the storage unit 30 as a data body, and imparts an arithmetic circuit ID of each arithmetic circuit 41 for executing the processing A and the processing B to data body (step S11 of FIGS. 1 and 2).

The arithmetic circuit ID may be described in the program or stored in the auxiliary storage device 32 in correspondence with the program. The control unit 20 imparts “#1” and “#2”, which are arithmetic circuit IDs of the arithmetic part 40-1 for executing each of the processing A and B, to the processing data as the data body from the head in the order of the processing. Hereinafter, the whole data made up of the data body and the arithmetic circuit ID imparted to the data body is also referred to as data with an ID. The arithmetic circuit ID functions as a destination of the data body, that is, an address. The arithmetic circuit ID also identifies the arithmetic part 40 having the arithmetic circuit 41 and the transmission circuit 42 connected to the arithmetic circuit 41.

The control unit 20 transmits the data with an ID to the arithmetic circuit 41-1 with the head “#1” as an arithmetic circuit ID (step S12). The data with ID is transmitted via the communication line 50 and the transmission circuit 42-1 (refer also to a dashed line arrow A1 of FIG. 1). As will be described below, the processing A performed by the arithmetic circuit 41-1 and the processing B performed by the arithmetic circuit 41-2 are executed with the transmission of the data with ID as a trigger. In this way, the control unit 20 which operates by executing the program performs control to cause the arithmetic circuits 41-1 and 41-2 to sequentially execute the processing A and the processing B.

A transmission circuit 42-1 for transmitting the data with ID deletes “#1” which is the head arithmetic circuit ID from the data with ID (step S13). The arithmetic circuit 41-1 executes processing A on the data body of the data with ID from which “#1” is deleted (step S14). The format or the like of the arithmetic circuit ID is predetermined, and each arithmetic circuit 41 including the arithmetic circuit 41-1 is configured to be able to recognize the presence or absence of the arithmetic circuit ID and the head and the end of the data body. The arithmetic circuit 41-1 generates new data with ID in which the arithmetic result obtained by the processing A (also referred to as processing data after the processing A, the processing result of the processing A, etc.) is a new data body. The data with ID is data in which “#2” is imparted to the data body.

The arithmetic circuit 41-1 transmits the generated data with ID to an arithmetic circuit 41-2 with the head “#2” as a destination and with the “#2” as an arithmetic circuit ID (step S15). The data with ID is transmitted via the transmission circuit 42-1, the communication line 50 and the transmission circuit 42-2 (refer also to a dashed line arrow A2 of FIG. 1). In this transmission processing, the transmission circuit 42-1 that receives the data with ID from the arithmetic circuit 41-1 may notify the control unit 20 of the reception. In this case, the transmission timing of the data with ID may be controlled by the control unit 20 which has received the notification. For example, the control unit 20 instructs the transmission circuit 42-1 to transmit data with ID at a predetermined timing.

The transmission circuit 42-2 which transmits the data with ID deletes “#2” which is the head arithmetic circuit ID from the data with ID (step S16). Thus, the arithmetic circuit ID is not imparted to the data body. The arithmetic circuit 41-2 executes processing B on the data body (step S17). The arithmetic result obtained by the processing B is processing data after a series of processing of this time, that is, a final processing result, and is transmitted from the arithmetic circuit 41-2 to the transmission circuit 42-2 as a new data body. Here, the transmission circuit 42 of each arithmetic part 40 is configured to transmit the data body as a final processing result to the main storage device 31 of the storage unit 30 when the arithmetic circuit ID is not imparted to the data body from the arithmetic circuit 41. Therefore, the transmission circuit 42-2 transmits a data body (that is, a final processing result) from an arithmetic circuit 41-2 to which the arithmetic circuit ID is not attached to the main storage device 31 via the communication line 50 (steps S18, also referred to a dashed line arrow A3 of FIG. 1). The transmission circuit 42-2 may notify the control unit 20 of the reception of the data body when it receives the data body. The control unit 20 can recognize that, when a notification is received from the transmission circuit 42-2 on a program, the processing B is completed, in other words, a series of processing to be executed by the arithmetic circuit 41 designated by the program is completed. The control unit 20 may perform a control of transmitting the data of a processing result received by the transmission circuit 42-2 to the main storage device 31 by executing interruption processing when receiving the notification.

### (Detailed Configuration and Operation of Transmission Circuit 42)

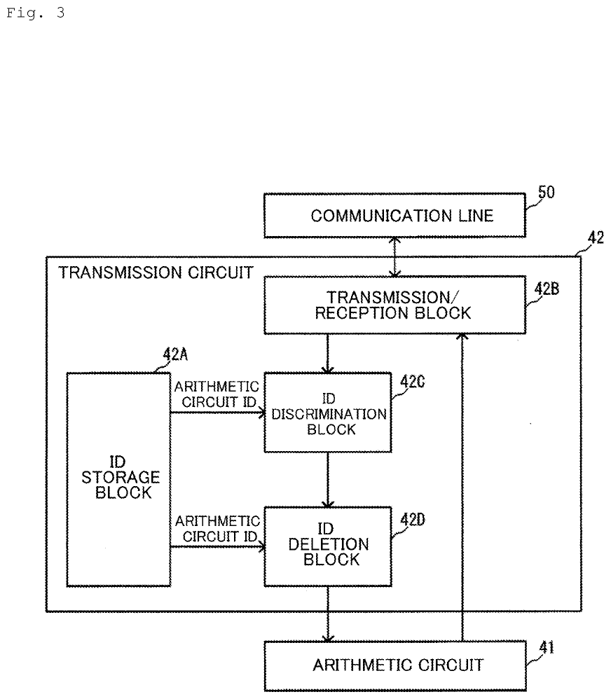

As shown in FIG. 3, the transmission circuit 42 includes an ID storage block 42A, a transmission/reception block 42B, an ID determination block 42C, and an ID deletion block 42D. Not only the data with ID and the data as the final processing result, but also various data output to the communication line 50 are input to the transmission circuit 42.

The ID storage block 42A stores the arithmetic circuit ID of the arithmetic circuit 41 in the same arithmetic part 40. For example, the ID storage block 42A of the arithmetic part 40-1 stores the arithmetic circuit ID “#1” of the arithmetic circuit 41-1.

The transmission/reception block 42B sends various data input to the transmission circuit 42 to the ID determination block 42C according to a mounted protocol.

The ID determination block 42C extracts the arithmetic circuit ID at the head of data from the transmission/reception block 42B. The ID determination block 42C determines whether the extracted arithmetic circuit ID coincides with the arithmetic circuit ID stored in the ID storage block 42A. When the arithmetic circuit ID cannot be extracted or both IDs do not match as a result of comparison, the data sent to the arithmetic part 40 is not a processing target in the arithmetic circuit 41 of the arithmetic part 40. In this case, the ID determination block 42C discards the input data without supplying it to the ID deletion block 42D of the next stage. On the other hand, when the two IDs coincide with each other, the data sent to the arithmetic part 40 is data with ID, and becomes a processing target in the arithmetic circuit 41 of the arithmetic part 40. In this case, the ID determination block 42C sends the data with ID to the ID deletion block 42D of the next stage. If the arithmetic circuit ID of head of the data with ID is “#1”, the data with ID is sent to the arithmetic circuit 41-1 only by the transmission circuit 42-1 of the arithmetic part 40-1 as will be described later. In this way, the data with ID is transmitted to the arithmetic circuit 41 identified by the head arithmetic circuit ID.

The ID deletion block 42D deletes the arithmetic circuit ID integrated with the arithmetic circuit ID stored in the ID storage block 42A from the ID determination block 42C, and sends the data with ID after deletion to the arithmetic circuit 41.

When the transmission/reception block 42B receives the data with ID or a final processing result as a data body to which the arithmetic circuit ID is not imparted from the arithmetic circuit 41, the received data is output to a communication line 50. The data with ID is transmitted to the arithmetic circuit 41 of the head arithmetic circuit ID by each transmission circuit 42. The final processing result is transmitted to the main storage device 31 of the storage unit 30. The transmission/reception block 42B transmits, for example, data of the processing result to which the address of the main storage device 31 is imparted.

In the present embodiment, although an example in which only the processing A and B are executed by a program, that is, an example in which the arithmetic circuits 41-1 and 41-2 are connected and the processing flows of the processing A and B are executed sequentially is shown, the number of processing is not limited to two, and any number of processing may be used. The arithmetic circuit to be used may also be determined in accordance with the number of processing and the type of processing. For example, the arithmetic circuit 41-1, the arithmetic circuit 41-2 and the arithmetic circuit 41-3 for executing the processing N may be connected, and the processing A, the processing B and the processing N may be sequentially executed by these circuits. A plurality of arithmetic circuits of the same kind or different kinds are “connected”, and a plurality of processings for designating execution by the program may be sequentially executed by the plurality of connected arithmetic circuits 41. The plurality of arithmetic circuits of the same kind or different kind are “connected”, and a plurality of processings for designating execution by the program are sequentially executed by the plurality of connected arithmetic circuits 41, thereby making it possible to execute various processing designated by the program without imposing a load on the control unit 20.

### Effects and Modified Example

In the present embodiment, a unique arithmetic circuit ID is imparted to each of the arithmetic circuits 41, and when a plurality of processings of the program are sequentially performed by the plurality of arithmetic circuits 41, processing data (data body) is transmitted and received between the arithmetic circuits 41 on the basis of the arithmetic circuit ID. Therefore, there is no writing of data (data body) after processing in a certain arithmetic circuit 41 to the storage unit 30, particularly the main storage device 31, and transmission from the main storage device 31 to the arithmetic circuit 41-2. Also, the bottleneck of data transmission by the control unit 20 is not generated. Therefore, the throughput of the electronic computer 10 is improved. In addition, effects such as lower power consumption, lower latency, lighter programs, improved computer stability, and improved usability can be obtained.

In the present embodiment, the control unit 20 imparts the arithmetic circuit ID to the processing data (data body), but a dedicated module may be provided for this application. The arithmetic circuit ID may be defined and assigned by a program as described above, or may be created and assigned by a compiler.

A communication protocol used in the control unit 20, the storage unit 30, the arithmetic part 40 (especially, the transmission circuit 42), and the communication line 50 is arbitrary, and a TCP/IP using IPv4 and/or IPv6 addresses as the arithmetic circuit ID, and a service chaining protocol of a network layer may be used. Further, the control unit 20, the storage unit 30, the arithmetic part 40 (especially, the transmission circuit 42), and the communication line 50 may be connected by the Ethernet standard, computer Express Link (CXL), Gene-Z or the like. The transmission circuit 42 may be separately provided outside the arithmetic part 40 such as an FPGA. In this case, the transmission circuit 42 may utilize the bus of the processor or the bridge function of the PCIe. The transmission circuit 42 may be a router or the like.

The arithmetic circuit 41 may be constituted by a processor such as a CPU. In this case, a storage unit (not shown) may be provided inside or outside the transmission circuit 42, and a subprogram for operating the arithmetic circuit 41 as each block may be stored in the storage unit. The arithmetic circuit 41 and the storage unit may be connected to the communication line 50, and the subprogram may be supplied to the arithmetic circuit 41 via the communication line 50. The program is supplied to the arithmetic circuit 41 via the communication line 50. As another example, the arithmetic circuit 41 may be a GPU or the like. In this case, a set of a processor for controlling the operation of the GPU and a storage unit for storing a program executed by the processor may be provided inside or outside the transmission circuit 42. The processor and the storage unit may be connected to the communication line 50, and the program may be supplied to the processor via the communication line 50.

In the present embodiment, the arithmetic circuit ID is set to “#1” to “#N” for convenience, but an IP address or a MAC address may be used as the arithmetic circuit ID.

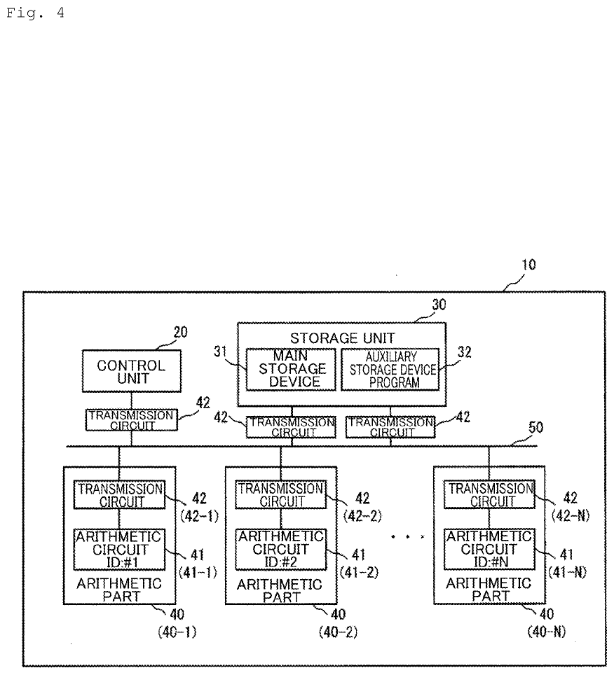

The transmission circuit 42 may be imparted to each module of the electronic computer 10. For example, as shown in FIG. 4, the control unit 20 and the storage unit 30 may be connected to the communication line 50 via the transmission circuit 42. In this case, the address of the control unit 20 or the like is stored in the ID storage block 42A of the transmission circuit 42 connected to the control unit 20 instead of the arithmetic circuit ID. In the ID storage block 42A of the transmission circuit 42 connected to the storage unit 30 (each of the main storage device 31 and the auxiliary storage device 32), an address of the main storage device 31 or the auxiliary storage device 32 or the like is stored instead of the arithmetic circuit ID.

### Second Embodiment

In the present embodiment, the processing ID for identifying each processing is set in a processing unit of a program, and the processing ID for processing to be executed by the arithmetic circuit having the arithmetic circuit ID is imparted to the processing data.

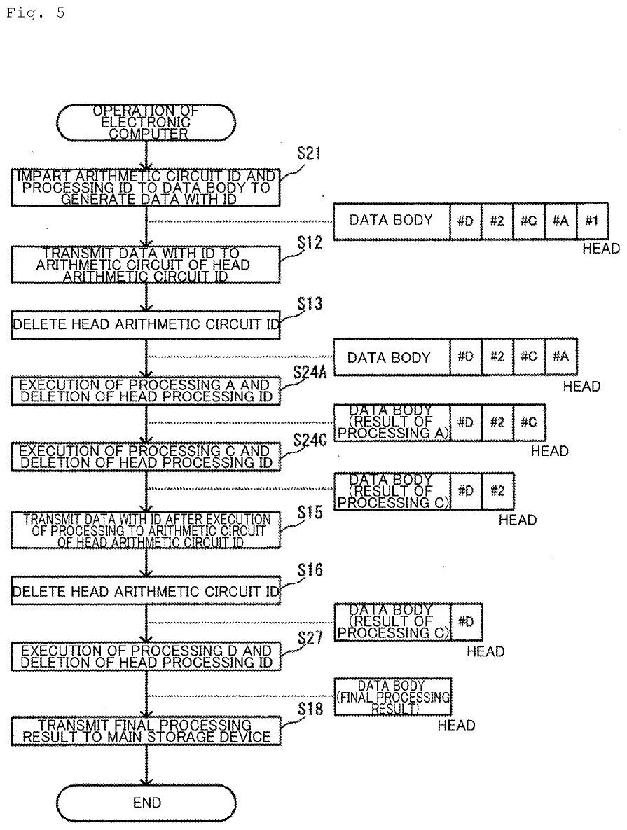

The present embodiments will be described below with reference to FIGS. 5 to 7. Repeated explanations of the first embodiment will be omitted as appropriate. The omission of explanation is the same for the third embodiment and subsequent embodiments, and repeated explanation of previous embodiment will be omitted as appropriate. An electronic computer according to the second embodiment has the same device configuration as that of the electronic computer 10 of FIG. 1. In this case, the arithmetic circuit 41-1 is able to execute the processing A, the processing B, and the processing C, and the arithmetic circuit 41-2 is able to execute the processing D. Hereinafter, the electronic computer according to the second embodiment is also referred to as an electronic computer 110. It is assumed that “#A” to “#D” are set as processing ID in the processing A to D, respectively.

### (Operation Example of Electronic Computer 110)

An example in which the electronic computer 110 executes processing A processing C→processing D on the processing data to be processed will be described below with reference to FIGS. 1 and 5. In the processing of FIG. 5, the control unit 20 imparts the arithmetic circuit ID of the arithmetic circuit 41 for performing processing and the processing ID of processing to be executed by the arithmetic circuit 41 to the processing data to be a data body according to a program (step S21). Here, the arithmetic circuit ID “#1”, the processing ID “#A” and “#C”, the arithmetic circuit ID “#2”, and the processing ID “#D” are imparted in order from the head. Each ID to be imparted is arranged from the head in the order of processing, in which the arithmetic circuit ID of the arithmetic circuit 41 and one or a plurality of processings IDs to be executed by the arithmetic circuit 41 are defined as one set. A plurality of processings ID in one set are also arranged from the head side in the execution order of the processing. The data body and each ID imparted to the data body are also referred to as data with ID (hereinafter, the same is also applied to data to which other ID is imparted) as a whole. The format of the processing ID is determined, and the arithmetic circuit 41 or the like can recognize the place of the processing ID in the data with ID.

After step S21, processing similar to steps S12 and S13 of FIG. 2 described above is performed. That is, the data with ID is transmitted to the arithmetic circuit 41-1 using the head “#1” of the data with ID as the arithmetic circuit ID, and at that time, the transmission circuit 42-1 deletes the “#1”.

Thereafter, the arithmetic circuit 41-1 executes the processing A indicated by the head processing ID “#A” to the data body, and deletes the “#A” (step S24A). Thereafter, the arithmetic circuit 41-1 sets the processing result of the processing A as a new data body, executes processing C indicated by the processing ID “#C” at the current head on the data body, and deletes “#C” (step S24B). Thus, the processed data after the processing C is obtained as the data body.

Thereafter, the processing data after the processing C is used as a data body, and the data with ID in which “#2” and “#D” remain are subjected to the same processing as the steps S15 and S16 in FIG. 2 described above. That is, data with ID is transmitted to the arithmetic circuit 41-2, and the head arithmetic circuit ID is deleted by the transmission circuit 42-2. The data with ID input to the arithmetic circuit 41-2 by deleting the arithmetic circuit ID has a processing ID “#D” at the head in addition to the data body.

Thereafter, the arithmetic circuit 41-2 executes processing D on the processing data and deletes “#D” (step S27). Thereafter, the same processing as the step S18 of FIG. 2 described above is executed, and the data body after the processing D is transmitted to the main storage device 31 as a final processing result.

### (Detailed Configuration and Operation of Arithmetic Circuit 41-1)

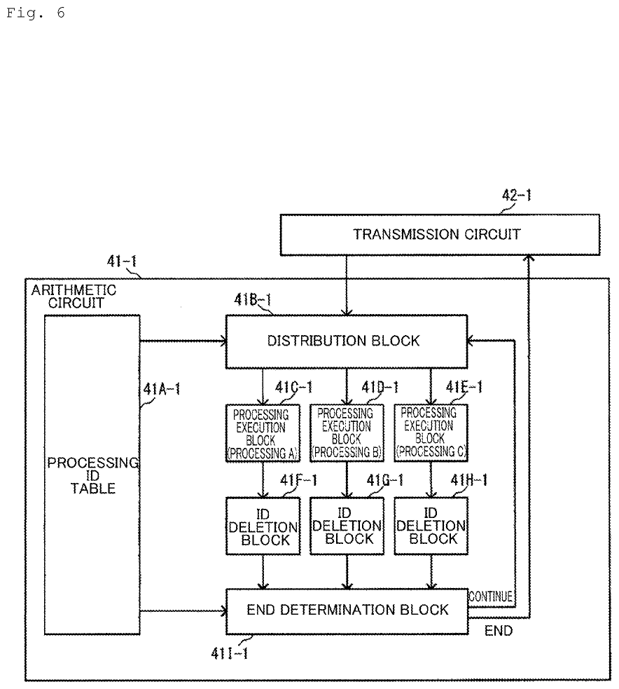

As shown in FIG. 6, the arithmetic circuit 41-1 includes a processing ID table 41A-1, a distribution block 41B-1, and processing execution blocks 41C-1 to 41E-1 for each executing processing A to C. The arithmetic circuit 41-1 further includes ID deletion blocks 41F-1 to 41H-1 for deleting the processing ID after each processing of the processing A to C, and an end determination block 41I-1.

In the processing ID table 41A-1, the processing ID and specific information for specifying the processing execution block for executing processing identified by the processing ID are associated with each processing ID. For example, the processing execution block 41C-1 for executing the processing A is associated with the processing ID “#A”. The data with ID input from the transmission circuit 42-1 to the arithmetic circuit 41-1 are first input to the distribution block 41B-1. The distribution block 41B-1 refers to the processing ID table 41A-1, using the head processing ID of the data with ID as a key, and acquires specific information corresponding to the processing ID as the key. The distribution block 41B-1 inputs data with ID to a processing execution block specified by the specified information acquired in the processing execution blocks 41C-1 to 41E-1.

The processing execution block 41C-1 executes processing A on the data body of the input data with ID, and generates new data with ID with the processing result of the processing A as the data body. The processing execution block 41C-1 inputs the generated data with ID to the ID deletion block 41F-1 of a post stage. The ID deletion block 41F-1 deletes the head processing ID (#A) of the data with ID, and outputs the data with ID after deletion to the end determination block 41I-1.

Similarly, the processing execution block 41D-1 executes processing B on the data body of the input data with ID. The ID deletion block 41G-1 deletes the head processing ID (#B) of the data with ID, and outputs the data with ID after deletion to the end determination block 41I-1.

Similarly, the processing execution block 41E-1 executes processing C on the data body of the input data with ID. The ID deletion block 41H-1 deletes the head processing ID (#C) of the data with ID, and outputs the data with ID after deletion to the end determination block 41I-1.

When the executed processing is the final processing in the program, the data to be transmitted to the end determination block 41I-1 may become a data body (final processing result) to which a processing ID or the like is not imparted, instead of data with ID.

The end determination block 41I-1 determines which processing ID of the processing ID table 41A-1 is included in received reception data (data with ID or final processing result). Since the processing is continued when it is included, the received data (data with ID) are input again to the distribution block 41B-1. On the other hand, if they do not match, the received data (data with ID or the final processing result) is output to the transmission circuit 42.

When the processing A, the processing C and the processing D are executed as described above, in the arithmetic circuit 41-1, processing A performed by the processing execution block 41C-1 and deletion of the processing ID “#A” are performed on the processing data with ID by the ID deletion block 41F-1. Further, processing C performed by the processing execution block 41E-1 and deletion of the processing ID “#C” by the ID deletion block 41H-1 are performed on the processing data with ID.

### (Detailed Configuration and Operation of Arithmetic Circuit 41-2)

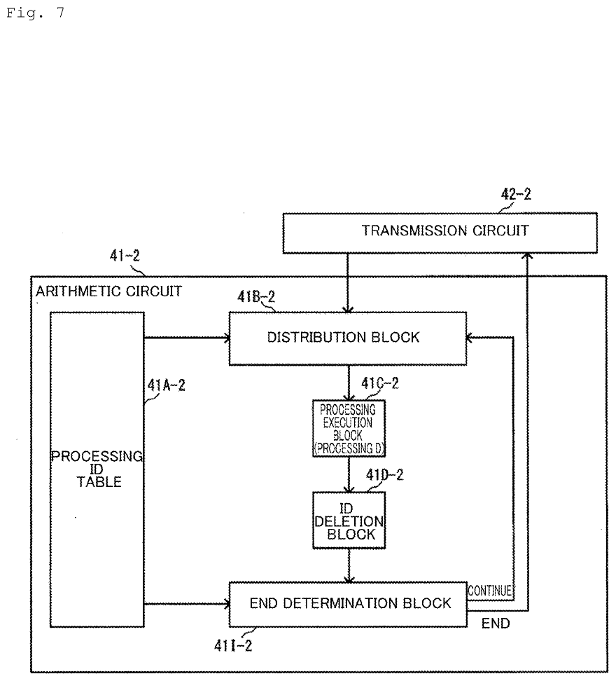

As shown in FIG. 7, the arithmetic circuit 41-2 includes a processing ID table 41A-2, a distribution block 41B-2, and a processing execution block 41C-2 for executing processing D. The arithmetic circuit 41-2 further includes an ID deletion block 41D-2 for deleting the processing ID after the processing D, and a final determination block 41I-2. In the processing ID table 41A-2, the processing ID “#D” of the processing D is associated with specific information for specifying a processing execution block 41C-2 for executing the processing D. The other configurations are the same as those of the arithmetic circuit 41-1 and thus their descriptions will be omitted. When the data with ID is provided with “#D” as the processing ID, the processing D is executed by the arithmetic circuit 41-2.

### Effects and Modified Example

In the present embodiment, a plurality of processings can be implemented in one arithmetic circuit 41, and for example, in a device such as an FPGA, there is an advantage that the utilization efficiency of the circuit increases.

In the present embodiment, #A to #D are used as the processing ID. The processing ID is not limited to this, but may be, for example, an IP address, a MAC address, or a simple numerical value. Further, the processing ID may be configured to indicate the position of a portion to be processed, such as a pointer of the memory.

### Third Embodiment

In the present embodiment, parallel processing in the arithmetic circuit 41 can be performed, by inserting a parallel tag for designating parallel execution of processing in addition to the processing ID.

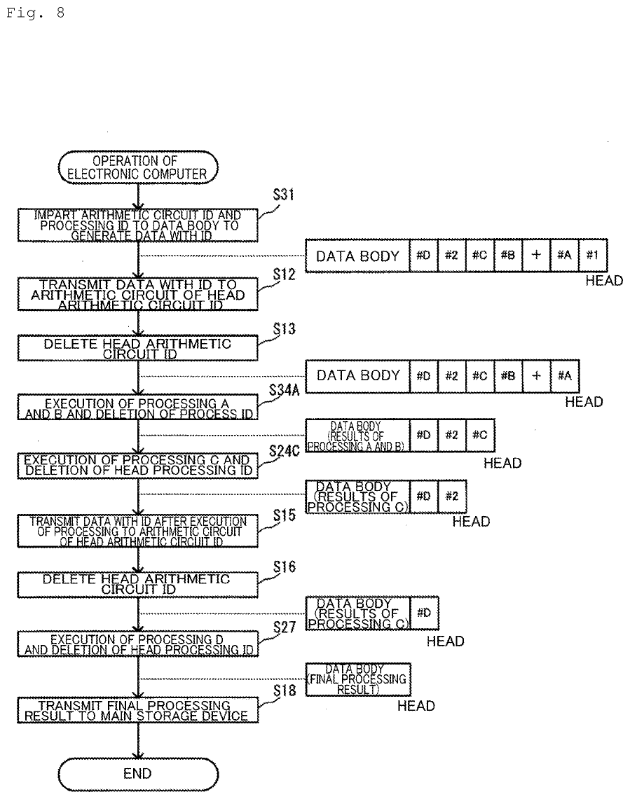

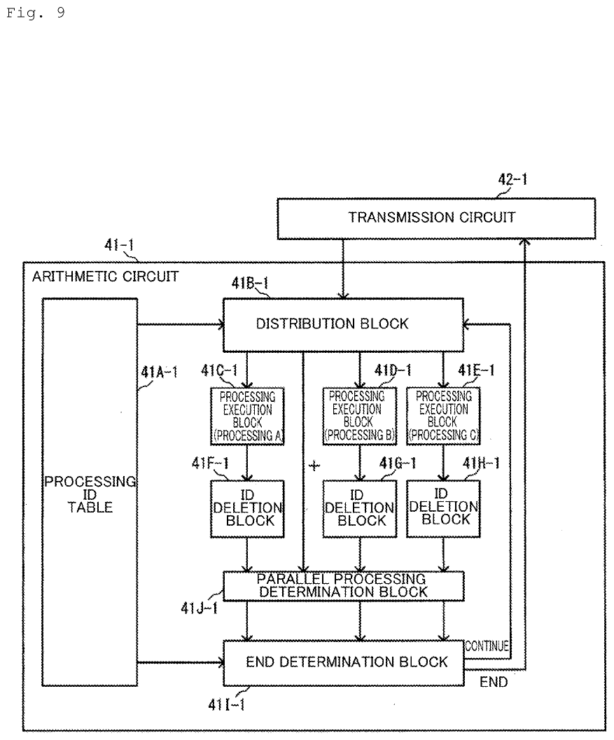

The present embodiment will be described below with reference to FIGS. 8 and 9. An electronic computer according to the third embodiment has the same device configuration as that of the electronic computer 110. However, the arithmetic circuit 41-1 can execute processing A and processing B in parallel. Hereinafter, the electronic computer according to the third embodiment is also referred to as an electronic computer 210.

### (Operation Example of Electronic Computer 210)

An example in which the electronic computer 210 executes processing A and processing B in parallel on the processing data to be processed, and then executes processing C and processing D sequentially will be described with reference to FIGS. 1 and 8. In the processing shown in FIG. 8, the control unit 20 imparts the arithmetic circuit ID of an arithmetic circuit 41 for performing processing and the processing ID of processing to be executed by the arithmetic circuit 41 to the processing data to be a data body according to a program (step S31). Here, the arithmetic circuit ID “#1”, processing ID “#A” to “#C”, arithmetic circuit ID “#2”, and processing ID “#D” are assigned in order from the head. However, since the processing A and the processing B are executed in parallel in this case, the control unit 20 inserts a parallel tag “+” indicating parallel execution between “#A” and “#B” that identify processing A and B, respectively. “+” indicates that two processing identified by the preceding and succeeding processing ID are executed in parallel.

After step S31, processing similar to steps S12 and S13 of FIGS. 2 and 5 described above is performed. Thereafter, the arithmetic circuit 41-1 determines whether a tag “+” exists immediately after the head processing ID “#A”. If there is no “+”, the processing A identified by “#A” is executed. However, here, since there is “+”, parallel execution by the processing A and the processing B identified by the processing ID “#A” and “#B” before and after “+” is performed on the data body of the data with ID (step S34A). Further, “#A”, “+”, and “#B” are deleted (step S34A). Thereafter, the processing result is defined as a new data body, and on the basis of the data with ID from which “#A”, “+”, and “#B” are deleted, processing similar to the step S24C of FIG. 5 is performed, and processing similar to the steps S15, S16, S27, and S18 of FIGS. 2 and 5 is performed. The determination is also performed in a step S24C. The processing C and D are executed by the above-mentioned each processing.

### (Detailed Configuration and Operation of Arithmetic Circuit 41-1)

As shown in FIG. 9, the arithmetic circuit 41-1 includes a parallel processing determination block 41J-1 in addition to the configuration (see FIG. 6) of the arithmetic circuit 41-1 of the second embodiment. A flag indicating that parallel processing is performed can be supplied from the distribution block 41B-1 to the parallel processing determination block 41J-1. The distribution block 41B-1 determines whether a tag “+” exists immediately after the processing ID at the head of the data with ID, and when the tag “+” exists, supplies the flag to the parallel processing determination block 41J-1. The distribution block 41B-1 refers to the processing ID table 41A-1, and acquires specific information corresponding to processing ID before and after “+” in the data with ID. Here, specific information for specifying each of the processing execution blocks 41C-1 and 41D-1 is acquired. In this case, the distribution block 41B-1 inputs the data body to the processing execution blocks 41C-1 and 41D-1, and thus, the processing A and B are executed in parallel. The distribution block 41B-1 may divide the data body and input it to the processing execution blocks 41C-1 and 41D-1, respectively, or input the data body to the processing execution blocks 41C-1 and 41D-1 as it is, depending on the processing contents.

In the above-mentioned parallel execution, in some cases, the execution time may be different between the processing A and the processing B. When the flag is supplied, the parallel processing determination block 41J-1 holds the processing result until both processing A and processing B executed in parallel are completed, and when both processing A and processing B are completed, the parallel processing determination block 41J-1 outputs the parallel processing results of the processing A and the processing B to an end determination block 41I-1.

### Effects and Modified Example

With the above-described configuration, it is possible to perform parallel processing by hardware such as FPGA, and to reduce the latency of the entire processing.

The parallel processing is not limited to the parallel execution of the continuous processing such as the processing A and B. For example, when the processing A and the processing C can be executed in parallel, “#A”, “+”, “#C”, “#B”, and the like may be arranged from the head. Further, three or more processes may be executed in parallel. For example, as “#A”, “+”, “#B”, “+”, and “#C”, three or more parallel execution can be performed by inserting a plurality of tags. Further, parallel execution may be represented by a numerical value indicating the number of processing ID to be executed in parallel, such as “+2”. In the case of “+2”, the processing of two subsequent processing ID of the numerical value becomes the target of parallel execution.

### Fourth Embodiment

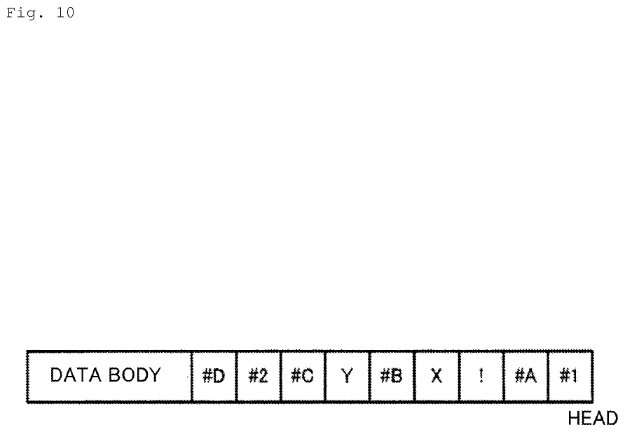

In addition to or in place of the parallel tag of the third embodiment, a branch tag indicating a branch of processing may be adopted. For example, when the processing A to D are executed, the processing B is executed when the result of the processing A is X, and the processing C is executed when the result of the processing A is Y. In this case, as shown in FIG. 10, in the data body, “#1”, “#A”, “!”, “X”, “#B”, “Y”, “#C”, “#2”, and “#D” are imparted from the head. “!” after “#A” indicates the branch of the processing A. The subsequent “X” designates execution of the processing B when the processing result of the processing A is the processing result corresponding to “X” together with the subsequent “#B”. “Y” designates execution of the processing C when the processing result of the processing A is the processing result corresponding to “Y” together with the subsequent “#C”. The arithmetic circuit 41-1 to which the data with ID from which “#1” is deleted by the transmission circuit 42-1 is input executes the processing A and deletes “#A” according to “#A”. Thereafter, the arithmetic circuit 41-1 reads up to “X”, “#B”, “Y” and “#C” according to “!”, and executes the processing B if the processing result of processing A corresponds to X. When the processing result is Y, the arithmetic circuit 41-1 executes processing C.

The configuration of the arithmetic circuit 41-1 may be the same as that of FIG. 6, for example. For example, after the processing A, the end determination block 41I-1 uses the processing result after the processing A as the data body, and inputs data with ID to which “!”, “X”, “#B”, “Y”, “#C”, “#2”, and “#D” are imparted to the distribution block 41B-1. A distribution block 41B-1 reads “!”, “X”, “#B”, “Y”, and “#C” at the head of the input data with ID, and determines whether the data body, which is the result of processing A, corresponds to X or Y. When the processing result is X, the distribution block 41B-1 refers to a processing ID table and inputs data with ID to the processing execution block 41D-1 corresponding to “#B”. At this time, the distribution block 41B-1 deletes “!”, “X”, “Y”, and “#C” in the data with ID.

When the processing result is Y, the distribution block 41B-1 refers to the processing ID table and inputs data with ID to the processing execution block 41E-1 corresponding to “#C”. At this time, the distribution block 41B-1 deletes “!”, “X”, “#B”, and “Y” in the data with ID. If the result of the processing does not correspond to both of “X” and “Y”, the whole series of processing by the program may be ended assuming that an abnormality has occurred.

As described above, in the present embodiment, the branch processing can be executed in the arithmetic circuit 41 by inserting the branch tag. The branch may be performed over a plurality of arithmetic circuits 41. The tag to be inserted is not limited to a branch tag, and various tags may be used. For example, a tag for executing loop processing may be prepared.

### Fifth Embodiment

In the present embodiment, instead of the processing ID and various tags, data ID (ID determined according to processing on the data body) for identifying the data body is imparted to the data body. Each arithmetic circuit 41 executes processing on the basis of the data ID. In the above description, the processing ID and the like are imparted to the data body, but when the processing increases, the data amount of the data with ID increases, which causes a decrease in the throughput of the electronic computer. In the present embodiment, individual data IDs are imparted to the processing data to be the data body, and the processing necessary for each data ID is held in the table by the arithmetic circuit 41, thereby reducing the amount of data to be imparted to the processing data.

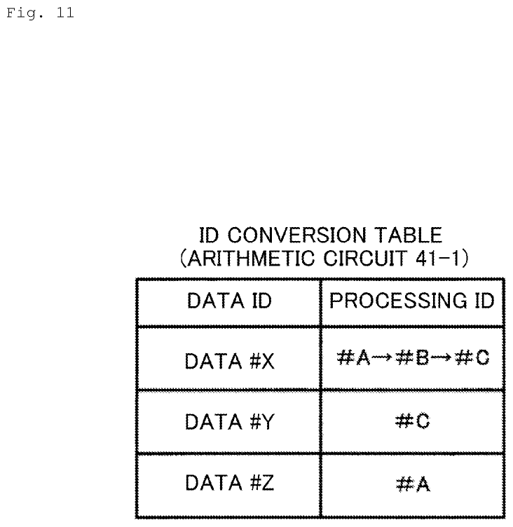

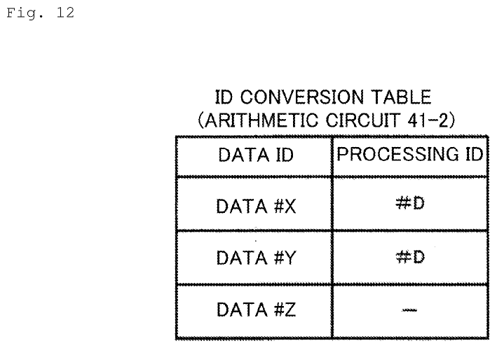

Hereinafter, the present embodiment will be described with a focus on handling of data ID. The electronic computer according to the fifth embodiment has the same device configuration as that of the electronic computer 10 of FIG. 1. In this case, the arithmetic circuit 41-1 is able to execute the processing A, the processing B, and the processing C, and the arithmetic circuit 41-2 is able to execute the processing D. Hereinafter, the electronic computer according to the fifth embodiment is also referred to as an electronic computer 410. It is assumed that “#A” to “#D” are set as processing ID in the processing A to D, respectively. It is assumed that “data #X” to “data #Z” are set as the data ID. It is assumed that each arithmetic circuit 41 stores the ID correspondence table indicating the correspondence between the data ID and the processing ID. For example, the arithmetic circuit 41-1 includes an ID conversion table shown in FIG. 11. The arithmetic circuit 41-2 includes an ID conversion table shown in FIG. 12. In each ID conversion table, a processing ID of processing executable by the arithmetic circuit 41 provided with the ID conversion table is associated with each data ID. The format of the data ID is determined, and the arithmetic circuit 41 or the like can recognize the location or the like of the data ID in the data with ID.

### (Operation Example of Electronic Computer 410)

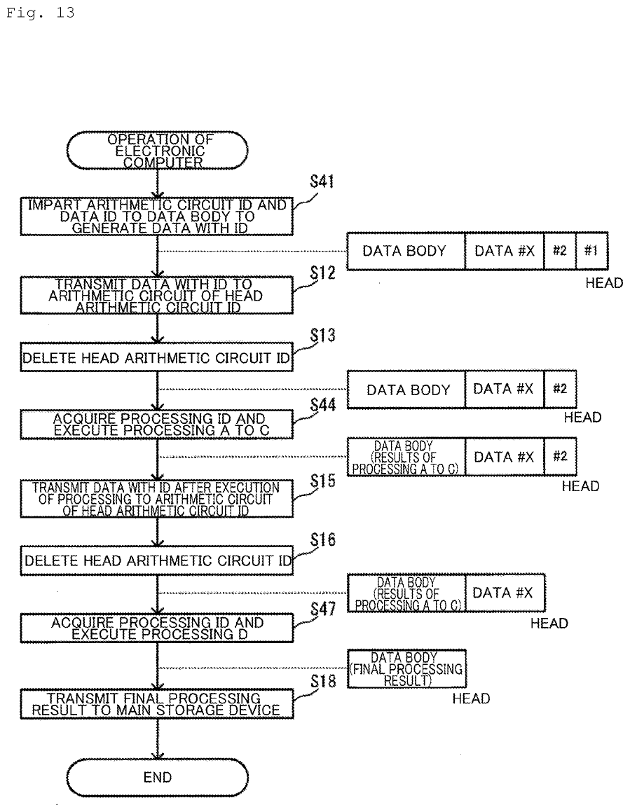

An operation example of the electronic computer 410 will be described with reference to FIGS. 1 and 13. Here, it is assumed that the processing A to C are executed by the arithmetic circuit 41-1, and the processing D is executed by the arithmetic circuit 41-2. In the processing of FIG. 13, the control unit 20 imparts the arithmetic circuit ID of the arithmetic circuit 41 that performs processing, and a data ID capable of specifying processing to be executed by the arithmetic circuit 41, to the processing data that is a data body in accordance with a program (step S41). Here, it is assumed that the arithmetic circuit ID “#1”, the arithmetic circuit ID “#2”, and the data #X” as the data ID are imparted in order from the head.

After step S41, processing similar to steps S12 and S13 of FIG. 2 described above is performed. That is, the data with ID is transmitted to the arithmetic circuit 41-1 having the head “#1” of the data with ID as the arithmetic circuit ID, and at that time, the transmission circuit 42-1 deletes “#1”.

Thereafter, the arithmetic circuit 41-1 acquires the processing ID associated with the data ID by referring to the ID conversion table shown in FIG. 11, using the data ID of the data with ID as a key (step S44). Here, since the data ID is “data #X”, “#A” to “#C” corresponding thereto are acquired. The arithmetic circuit 41-1 sequentially executes processing A, processing B, and processing C identified by the acquired processing ID.

Thereafter, the processing data after the processing C is used as a data body, and the same processing as the steps S15 and S16 of FIG. 2 described above are performed on the data with ID in which “#2” and “data #X” are left. That is, the data with ID is transmitted to the arithmetic circuit 41-2, and the head arithmetic circuit ID “#2” is deleted by the transmission circuit 42-2. The data with ID input to the arithmetic circuit 41-2 by deleting the arithmetic circuit ID has “data #X” at the head in addition to the data body.

Thereafter, the arithmetic circuit 41-2 refers to the ID conversion table shown in FIG. 12, using the data ID of the data with ID as a key, and acquires a processing ID associated with the data ID (step S47). Here, since the data ID is “data #X”, “#D” corresponding thereto is obtained. The arithmetic circuit 41-1 executes processing D identified by the acquired processing ID. Thereafter, the same processing as the step S18 of FIG. 2 described above is executed, and the data body after the processing D is transmitted to the main storage device 31 as the final processing result. At this time, the data ID may be deleted or not deleted.

### (Detailed Configuration and Operation of Arithmetic Circuit 41-1)

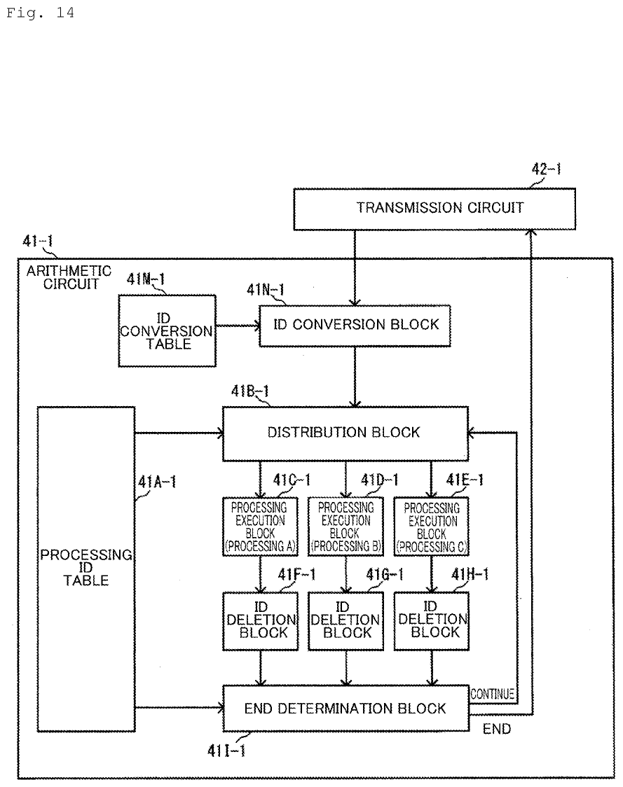

As shown in FIG. 14, the arithmetic circuit 41-1 includes, in addition to each block shown in FIG. 6, an ID conversion table 41M-1, and an ID conversion block 41N-1 shown in FIG. 11. This configuration is similar to that of the other arithmetic circuits 41. Data with ID supplied from the transmission circuit 42-1 is input to the ID conversion block 41N-1. The ID conversion block 41N-1 refers to the ID conversion table 41M-1, and acquires a processing ID corresponding to the data ID in the data with ID. The ID conversion block 41N-1 imparts the acquired processing ID to the data with ID in the processing order (also defined by the ID conversion table 41M-1) from the head, and outputs the data with ID after the application to the distribution block 41B-1. The distribution block 41B-1 performs the same operation as above, refers to the processing ID table 41A-1, and outputs data with ID to the processing execution block corresponding to the processing ID. Accordingly, execution of processing A or the like is realized.

The arithmetic circuit 41 may include an ID conversion table and an ID conversion block in addition to the blocks shown in FIG. 8 or the like. In such a case, the information associated with the data ID in the ID conversion table may include information for parallel processing or branching in addition to the processing ID.

### Effects and Modified Example

With the above configuration, by having the processing content in the table, it is not necessary to impart the processing ID or the like for designating the processing content to the data with ID, and the data amount of the data with ID can be suppressed, and as a result, the reduction in throughput can be suppressed.

The data ID may be prepared individually for each arithmetic circuit 41. The ID conversion table may be configured so that the processing to be executed by each arithmetic circuit 41 can be specified, using the data ID as a key. For example, the ID conversion table may store the address of the processing execution block in the pointer format, or may store information in a form that enables routing of the processing execution destination in the arithmetic circuit 41 in the next-hop format.

The data ID may be explicitly described in a program by a user in advance and stored in a storage unit.

### Sixth Embodiment

In the present embodiment, processing requests or program tasks provided by a plurality of users are processed. The electronic computer according to the present embodiment is also referred to as an electronic computer 510. The device configuration of the electronic computer 510 is the same as that of FIG. 1. For example, the user A requests the execution of the processing A to D, and the user B requests the execution of the processing C and D. It is assumed that a request for execution of processing by the user is input to the electronic computer 510 together with the processing data via a network or the like. In the same way, the processing A to C are executed by the arithmetic circuit 41-1, and the processing D is executed by the arithmetic circuit 41-2. The data with ID related to the request of a user A includes data #X as a data ID, and the data with ID related to the request of a user B includes data #Y as a data ID. The data #X is prepared for the user A, and the data #Y is prepared for the user B. That is, the difference between the users is specified by the data ID.

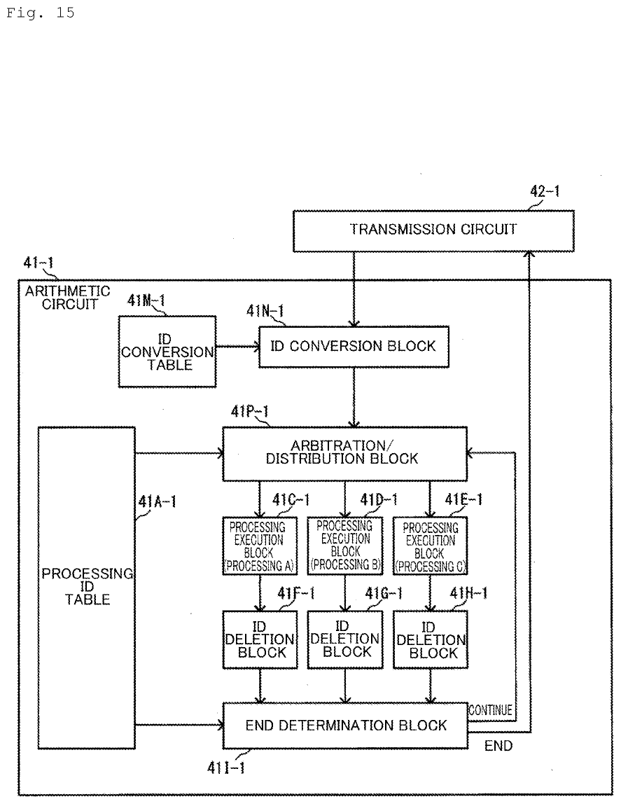

The arithmetic circuit 41-1 of the present embodiment has the same configuration as that of FIG. 14 as shown in FIG. 15, but includes an arbitration/distribution block 41P-1 instead of the distribution block 41B-1 of FIG. 14. There is a case where the timing of request for processing by a plurality of users or the like overlap. In other words, the processing requests may conflict with each other. Therefore, an arbitration/distribution block 41P-1 arbitrates the processing request, preferentially executes any of the processing of the competing processing request, and waits for the execution. FIGS. 11 and 12 are used as the ID conversion table. When the data with ID of the user A and the data with ID of the user B are simultaneously input, the arbitration/distribution block 41P-1 compares the data ID of each data with ID to determine the priority of the data to be processed. The priority is set for each data ID, and the arbitration/distribution block 41P-1 determines the priority on the basis of the setting. The arbitration/distribution block 41P-1 outputs data with ID to the processing execution block in the order of priority.

### Effects and Modified Example

With the above-described configuration, a plurality of users or program tasks can be executed by one electronic computer at the same time.

In the ID conversion table, priority information such as processing priority may be associated with each data ID. In this case, the arbitration/distribution block 41P-1 may acquire priority information by referring to an ID conversion table, and execute arbitration processing on the basis of the acquired priority information.

### Seventh Embodiment

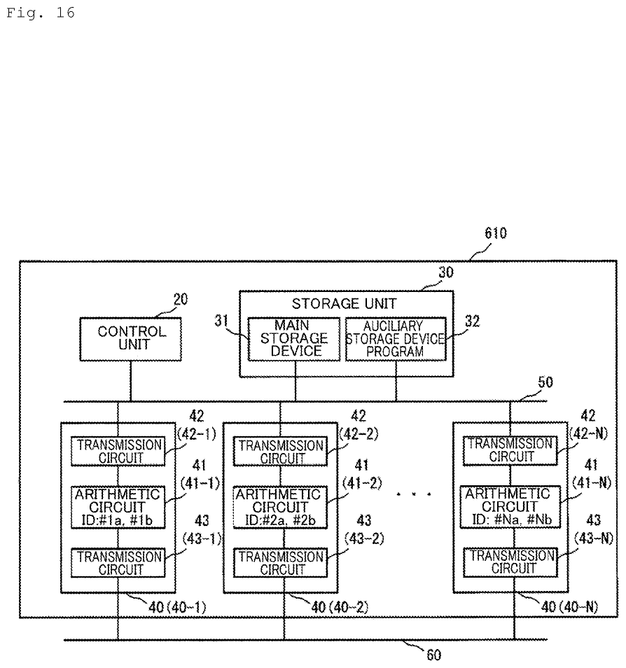

As shown in FIG. 16, an electronic computer 610 according to the present embodiment is basically the same as the configuration of FIG. 1, but each arithmetic part 40 includes a transmission circuit 43 connected to the arithmetic circuit 41 and the communication line 60 connected to an external network, in addition to the arithmetic circuit 41 and the transmission circuit 42. When the transmission circuit 43 is discriminated by the arithmetic circuit ID of the arithmetic circuit 41 of the connection destination, the transmission circuit 43 is also called transmission circuits 43-1 to 43-N.

In the present embodiment, the arithmetic circuit ID included in the data with ID transmitted from the communication line 50 to the arithmetic part 40 and the arithmetic circuit ID included in the data with ID transmitted from the communication line 60 to the arithmetic part 40 are different from each other even if the same arithmetic circuit 41 is identified. For example, in the arithmetic circuit 41-1, “#1a” is set as the arithmetic circuit ID on the communication line 50 side, and “#1b” is set as the arithmetic circuit ID on the communication line 60 side. Similarly, in the arithmetic circuit 41-2, “#2a” is set as the arithmetic circuit ID on the communication line 50 side, and “#2b” is set as the arithmetic circuit ID on the communication line 60 side. In this way, it is determined by the arithmetic circuit ID whether the data with ID is transmitted via the communication line 50 or via the communication line 60.

In the present embodiment, the transmission circuits 42 and 43 do not delete the arithmetic circuit ID included in the data with ID. For example, the arithmetic circuit 41 separates and holds the head arithmetic circuit ID from the data with ID from the transmission circuit 42 or 43. Thereafter, the arithmetic circuit 41 executes processing on the data body of the data with ID by the same method as described above, and when returning new data with ID or a final processing result obtained as a result of the processing to the transmission circuit 42 or 43, a reply destination is determined according to the held arithmetic circuit ID. For example, when the held arithmetic circuit ID is #1a, the data with ID or the final processing result is returned to the transmission circuit 42, and when the arithmetic circuit ID is #1b, the data with ID or the final processing result is returned to the transmission circuit 43.

As described above, it is possible to clarify from which path the data is sent by providing different arithmetic circuit IDs for each transmission path of the data with ID.

### Eighth Embodiment

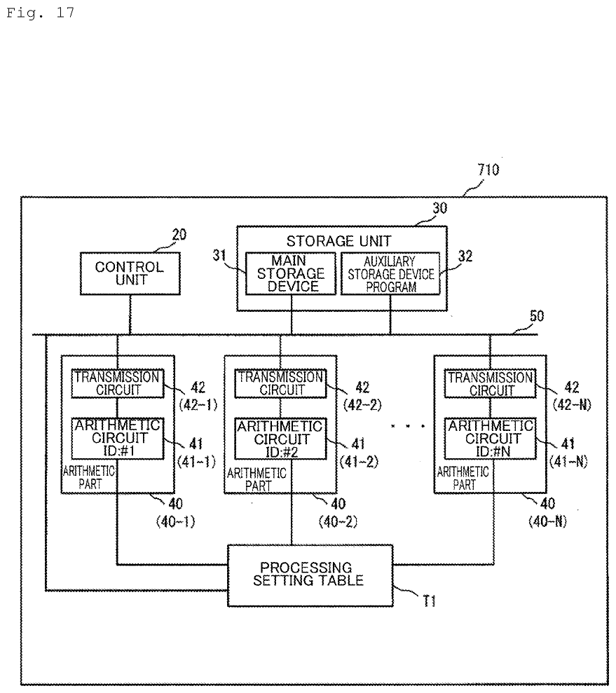

As shown in FIG. 17, an electronic computer 710 according to the present embodiment includes a processing setting table T1, in addition to the control unit 20, the storage unit 30, and the arithmetic part 40. The processing setting table T1 is stored in a storage unit accessible by the arithmetic circuit 41 or the transmission circuit 42. The processing setting table T1 may be stored in each arithmetic part 40 or in the storage unit 30. A configuration example of the processing setting table T1 will be described later.

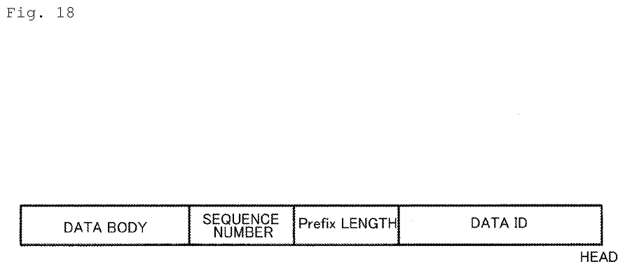

FIG. 18 shows the Data with ID handled by the electronic computer 710. The data with ID includes a data body, and a data ID, a prefix length, and a sequence number imparted to the head of the data body. The data ID identifies a data body (that is, processing data to be processed). The data ID is also referred to as a data address. The prefix length indicates the data length of the data ID. The data ID in the data with ID is specified by the prefix length. The sequence number is a number indicating the current stage (the number of times of execution of the processing) in the flow of the processing. Each time the processing is executed, the arithmetic circuit 41 increments the sequence number. The flow specifies which arithmetic circuit (Here, the arithmetic circuit is a concept also including a virtual arithmetic part to be described later, such as a processing execution block specified by the processing ID in addition to the arithmetic circuit 41. Hereinafter, the same also applies to arithmetic circuits without reference numerals in this embodiment.) the processing data is processed and in what order. The flow ID identifies the flow.

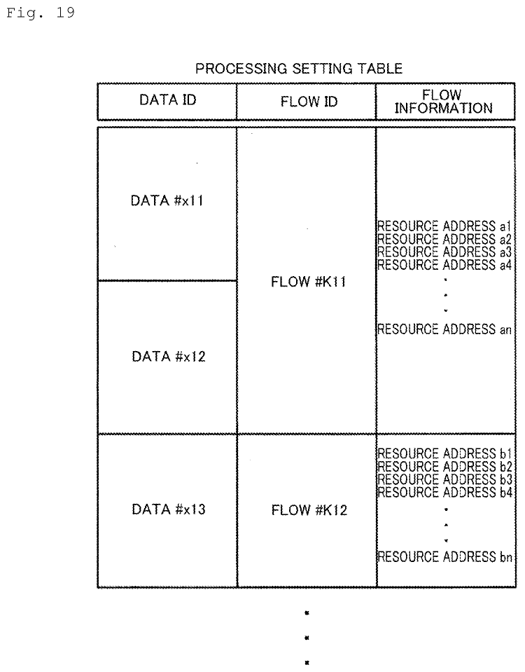

The processing setting table T1 is table data for determining a destination of data transmitted between a plurality of arithmetic circuits for sequentially executing a plurality of processings on the processing data, and as shown in FIG. 19, data ID, flow ID, and flow information are associated with each other. The flow information is configured of a plurality of resource addresses (destinations of the data) for identifying the arithmetic circuit (also including the processing execution block as described above) corresponding to the arithmetic circuit ID and the processing ID. The resource addresses correspond to the processing order, and here, they are arranged in the processing order to indicate the contents of the flow. The arrangement order of the resource addresses corresponds to the sequence number. For example, the third resource address specifies the arithmetic circuit (the arithmetic circuit 41. If the arithmetic circuit 41 is capable of executing a plurality of processings, the arithmetic circuit and the processing execution block therein) that executes the third processing, and corresponds to the sequence number “3”.

The data with ID and the first resource address may be generated in any way. The data with ID transmitted between the arithmetic circuits are transmitted together with a resource address. The transmission circuit 42 transmits the resource address and the data with ID to the arithmetic circuit 41, when information for specifying at least the arithmetic circuit 41 included in the resource address is information for specifying the arithmetic circuit 41 connected to the transmission circuit 42. When the information is not information for specifying the arithmetic circuit 41 connected to the transmission circuit 42, the resource address and the data with ID are discarded. Thus, the arithmetic circuit 41 receives the resource address and the data with ID specifying itself.

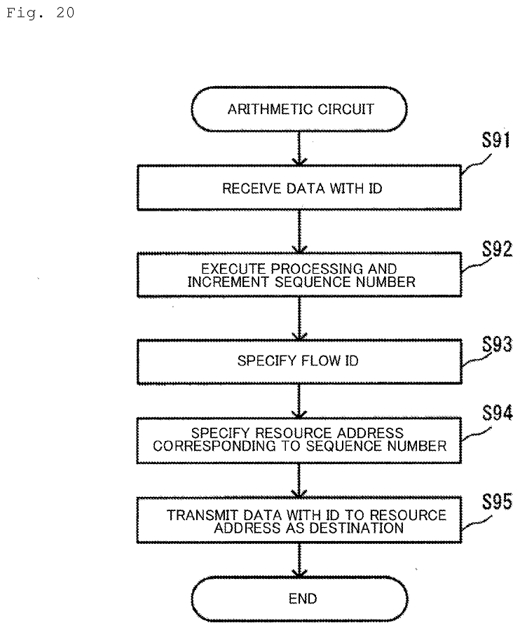

When the arithmetic circuit 41 (which may be an arithmetic circuit having no code) receives the resource address and the data with ID from the communication line 50 via the transmission circuit 42, the arithmetic circuit 41 performs the processing shown in FIG. 20. When the arithmetic circuit 41 receives the data with ID (step S91), the arithmetic circuit 41 performs processing on the data body by processing (processing in a processing execution block 41C-1 or the like designated by the resource address) designated by the resource address transmitted together with the data with ID, and increments a sequence number included in the data with ID (step S92). Thereafter, the arithmetic circuit 41 updates the data body to the data after processing. The arithmetic circuit 41 refers to the processing setting table with the data ID included in the data with ID as a key, and specifies the flow ID corresponding to the data ID (step S93). The arithmetic circuit 41 specifies a resource address corresponding to the sequence number included in the data with ID among resource addresses included in the flow information corresponding to the processing setting table in the specified flow ID (step S94). Thereafter, the arithmetic circuit 41 transmits the data with ID together with the resource address, with the specified resource address as a destination, more specifically, with the address of the arithmetic circuit specified by the resource address as a destination (step S95).

The data ID, the flow ID, and the resource address are all generated with 128-bit length equivalent to IPv6. Each ID and address are made up of Prefix and Suffix, and each length is determined by the kind of ID or address. Each ID and address are managed by a predetermined address management device, and address delivery or the like is performed.

The data ID is delivered to a device (a monitoring camera, a temperature sensor, etc.) which is a source of the processing data, and is imparted to the generated data. For example, a data ID and a prefix length are acquired from the address management device, and each time processing data is generated, an address is incremented within a range of the prefix, and an address is assigned to new data. The device of the generation source of the processing data places the data ID and the prefix length at the head of data generated by itself (i.e., data body or processing data), and transmits it to the electronic computer 710.

When the prefix is full, and a request from a user, a change in data, a change in processing flow, and the like occur, a new data address and prefix length are issued from the address management device.

The resource address is determined, for example, on the basis of location information (a DC name, a flow name, a rack number, Unit number) of the electronic computer 710. The resource address may include an address of prefix length 8 for specifying an electronic computer cluster to which the electronic computer 710 belongs, and an address of prefix length 16 from Suffix for specifying each computer in the cluster. The resource address further includes an address having a Prefix length of 32 from the Suffix of the arithmetic circuit 41 in the electronic computer 710, and an address having a Prefix length of 64 from the Suffix of the virtual arithmetic part (such as the above-mentioned processing execution block) configured in the arithmetic circuit 41. The resource address is determined on the basis of the location and type of the resource each time the resource (arithmetic circuit) is added. When the resource is deleted, the address is released. The information for specifying the resource is associated with the resource address and managed by the address management device. The information of the resources includes various kinds of information such as a cluster, an electronic computer, an arithmetic part, a virtual arithmetic part, processing contents and input/output regulations. Thus, since the resource address includes the belonging information indicating the belonging of the device including the arithmetic circuit, and the device information indicating the device including the arithmetic circuit, the position of the arithmetic circuit can be grasped, by checking the resource address. The resource address may be defined by IPv6 as a whole, and the address of the arithmetic circuit 41 in the resource address may be defined by IPv4.

The flow address may include an address of data to be processed in the flow. The user defines which resource is used to process the data in what order, and also defines the data to be processed in the processing flow. The flow address is imparted to the definition and stored in the flow management device.

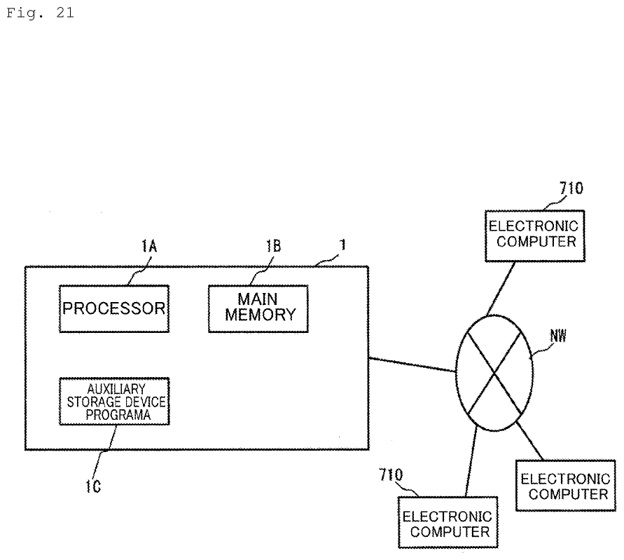

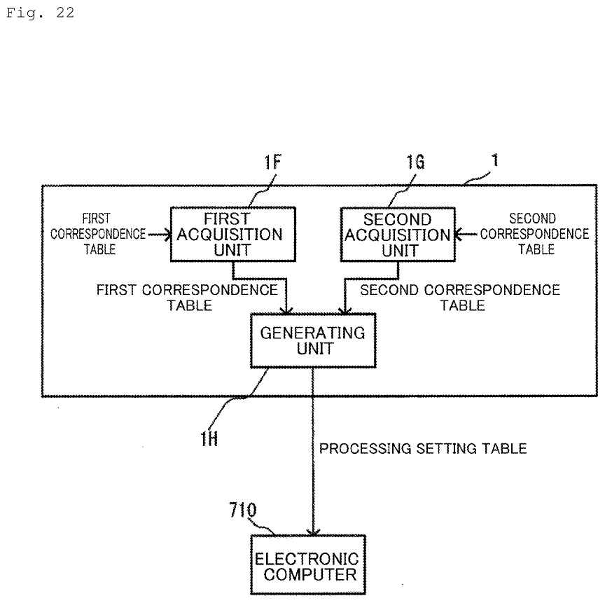

The processing setting table is generated by the data generating device 1 shown in FIG. 21. The data generating device 1 includes a server computer or the like. The data generating device 1 includes a processor 1A, a main memory 1B, and a nonvolatile storage unit 1C. The data generating device 1 is communicably connected to the electronic computer 710 via the network NW. The processor 1A executes the program stored in the storage unit 1C to operate as a first acquisition unit 1F, a second acquisition unit 1G, and a generating unit 1H shown in FIG. 22.

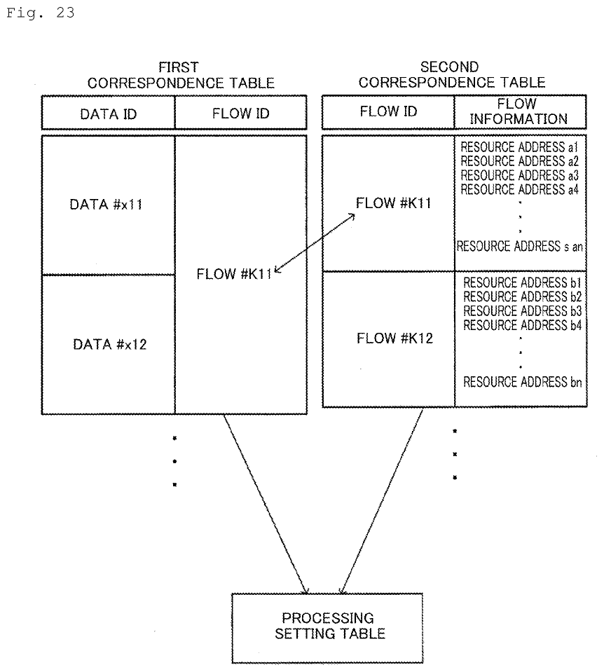

The first acquisition unit 1F acquires a first correspondence table (FIG. 23) which is data indicating a correspondence relation between the data ID and the flow ID. The second acquisition unit 1G acquires a second correspondence table which is data indicating a correspondence relation between the flow ID and the flow information. The first correspondence table and the second correspondence table (FIG. 23) may be stored and acquired in the storage unit 1C, or may be acquired from the outside of the data generating device 1 (for example, an address management device for managing the two correspondence tables or the like by an arbitrary method) via a network NW or the like. The generating unit 1H associates the acquired data ID of the first correspondence table with the acquired flow information of the second correspondence table via the flow ID as shown in FIG. 23 to generate a processing setting table (FIG. 19) in which the data ID and the flow information are associated with each other. The generating unit 1H supplies the generated processing setting table to the electronic computer 710 and stores it therein. In the processing setting table, the flow ID may be omitted. In this case, the arithmetic circuit 41 refers to a processing setting table using the data ID included in the data with ID as a key instead of the steps S93 and S94, and specifies the resource address corresponding to a sequence number included in the data with ID, among the resource addresses included in the flow information corresponding to the data with ID.

As shown in FIG. 23, a common flow ID may correspond to different data ID. More specifically, when the data specified by the data ID is data such as image data in which processing desired to be executed is the same but the content is different, the data ID is different, but the flow of the processing may be the same. In the above processing setting table, since the data ID and the flow information are associated with each other via the flow ID, the different data ID is associated with the same flow information, and thus, the capacity of the table data can be reduced.

When the data ID of the data with ID does not enter the processing setting table, the arithmetic circuit 41 inquires of the data generating device 1, acquires a flow ID or the like, and may cause the flow ID to enter the processing setting table. If the data ID of the data with ID does not enter the processing setting table, the arithmetic circuit 41 may notify the control unit 20 of the fact, and the control unit 20 may make the inquiry.

In the present embodiment, by clearly indicating the location information of each arithmetic circuit using the resource address, it is possible to find the most optimum arrangement of the arithmetic circuits in the case of executing the continuous processing. Also, by monitoring only the data address to be processed in each processing part, the processing order and the processing process of the data and the flow of the data can be traced (data traceability), high security, easy troubleshooting and visualization can be performed. Further, by utilizing an address management mechanism equivalent to IPv6, processing of a part for performing processing for delivering the data flowing via a network can be reduced in weight, and large-capacity data can be processed with low delay.

### Modification Example Etc.

A plurality of arithmetic circuits for executing a plurality of processings on the processing data as described above may be an integrated circuit such as an FPGA, a part of virtual circuits in the integrated circuit, or a processor such as a CPU. The arithmetic circuits may be connected to each other via a network other than the bus. The arithmetic circuit may be connected to a router or the like. The processing results of a part of the arithmetic circuits may be temporarily stored in the storage unit 30, instead of being directly input to other arithmetic circuits.

### Configuration and Modified Example in which Each of Above-Mentioned Embodiments are Used as an Example

(A) (1) The electronic computer may include, for example, a plurality of arithmetic circuits that sequentially execute a plurality of processings on processing data, and a control unit that executes a program and controls the plurality of arithmetic circuits to sequentially execute the plurality of processings. The plurality of processings include branch processing and parallel processing. As described above, the arithmetic circuit includes a processor such as a CPU and a GPU in addition to the arithmetic circuit 41 constituted by an integrated circuit such as an FPGA. The processor may be realized by executing a program to perform processing. The arithmetic circuit may be realized by a virtual arithmetic part such as a processing execution block 41C-1 which is a part of the arithmetic circuit 41.

For example, each of the plurality of arithmetic circuits may be provided with an arithmetic circuit ID. The arithmetic circuit ID may be, for example, one for identifying the arithmetic circuit. The arithmetic circuit ID may be realized by the resource address.

For example, the plurality of arithmetic circuits include a first arithmetic circuit for executing first processing among the plurality of processings, and a second arithmetic circuit for executing second processing for executing processing on a processing result of the first processing among the plurality of processings, and the first arithmetic circuit transmits the processing result of the first processing with the arithmetic circuit ID of the second arithmetic circuit as a destination.

With the above-described configuration, when the processing result of the first processing is transmitted from the first arithmetic circuit to the second arithmetic circuit, for example, since transmission by the control unit is not interposed, improvement in throughput is expected.

The plurality of arithmetic circuits may be housed in separate housings, and the electronic computer may be realized by a system including a plurality of housings.

(2) The electronic computer may further include a main storage device of the control unit, and the processing result of the first processing may be transmitted to the second arithmetic circuit without passing through the main storage device. Thus, the transmission of the processing result to the main storage device is eliminated, and the throughput is further improved.

(3) For example, the electronic computer may further include a plurality of first transmission circuits each connected to the plurality of arithmetic circuits, and a first communication line to which the plurality of first transmission circuits and the control unit are connected. The plurality of first transmission circuits may include a first-1 transmission circuit connected to the first arithmetic circuit, and a first-2 transmission circuit connected to the second arithmetic circuit. The first-1 transmission circuit may transmit the processing result of the first processing to the first communication line together with the arithmetic circuit ID of the second arithmetic circuit, and the first-2 transmission circuit may receive the processing result of the first processing transmitted together with the arithmetic circuit ID of the second arithmetic device from the first communication line and transmit the received processing result to the second arithmetic circuit. When the arithmetic circuit is the processing execution block or the like, the transmission circuit may be regarded as including the distribution block 41B-1, the end determination block 41I-1, the transmission circuit 42-1, and the like of FIG. 6. With such a configuration, the transmission of the processing result is easily realized.

(4) The plurality of arithmetic circuits may include a third arithmetic circuit that executes third processing for performing processing on the processing result of the second processing among the plurality of processings. The plurality of first transmission circuits may include a first-3 transmission circuit connected to the third arithmetic circuit. The first-2 transmission circuit may transmit the processing result of the second processing to the first communication line together with the arithmetic circuit ID of the third arithmetic circuit. The first-3 transmission circuit may receive the processing result of the second processing transmitted together with the arithmetic circuit ID of the third arithmetic device from the first communication line, and transmit the received processing result to the third arithmetic circuit. The arithmetic circuit ID of the second arithmetic circuit and the arithmetic circuit ID of the third arithmetic circuit may be imparted to the processing result of the first processing from the stage of transmission from the first-1 transmission circuit to the first communication line. Thus, the processing result can be sequentially transmitted by deleting the arithmetic circuit ID.

(5) The electronic computer may further include a second transmission circuit connected to the second arithmetic circuit and connected to the second communication line. A first circuit ID which is the arithmetic circuit ID and a second circuit ID different from the first circuit ID may be attached to the second arithmetic circuit. The second arithmetic circuit may be configured such that data to be processed by the second processing is input from the first communication line via the first-2 transmission circuit together with the first circuit ID, or input from the second communication line via the second transmission circuit together with the second circuit ID. The second arithmetic circuit may transmit data (processing result) obtained by executing the second processing on the data to be processed to the first communication line via the first-2 transmission circuit when the first circuit ID is input, and may transmit the data to the second communication line via the second transmission circuit, when the second circuit ID is input Thus, the processing result can be correctly returned to the transmission line of the supply source of the data to be processed.

(6) The second arithmetic circuit may be capable of executing a plurality of kinds of processing including the second processing, data capable of specifying processing to be executed by the second arithmetic circuit may be imparted to the processing result, and the second arithmetic circuit may perform processing on the processing result specified on the basis of data attached to the processing result. Thus, the throughput can be improved, while making the second arithmetic circuit execute a plurality of processings.

(7) The second arithmetic circuit refers to a table on the basis of the data to specify processing to be executed. Thus, the amount of data transmitted together with the processing result is reduced.

(8) The data may include data for designating branch of processing or parallel execution of a plurality of processings. Thus, the throughput is improved for various kinds of processing.

(9) When processing requests of the first processing on the first processing target data and the first processing on the second processing target data conflict with each other, the first arithmetic circuit may execute one of both first processing preferentially according to a predetermined priority order. Thus, appropriate processing is performed for a plurality of processings requests.

(B) (1) The data generating device generates table data for determining the destination of the processing data transmitted between a plurality of arithmetic circuits which sequentially executes a plurality of processings on the processing data to be processed. The data generating device includes a first acquisition unit that acquires a first correspondence table between a data ID for identifying the processing data and a flow ID for identifying a flow identifying which arithmetic circuit processes the processing data in what order, and a second acquisition unit that acquires a second correspondence table with the flow information that specifies the flow ID and the content of the flow identified by the flow ID according to the order of the destinations (more specifically, destinations and the order). Further, the data generating device associates the acquired data ID of the first correspondence table with the acquired flow information of the second correspondence table via a flow ID, and generates the table data in which the data ID and the flow information are associated with each other. With such a configuration, table data for determining the destination of data transmitted between a plurality of arithmetic circuits can be suitably generated. The program for operating the electronic computer as the respective parts may be stored in, for example, a non-volatile storage medium, more specifically, in an electronic computer-readable non-temporary storage medium.

(2) The generating unit may generate the table data in which the data ID, the flow ID, and the flow information are associated with each other. Thus, the flow can be specified on the table data. The first correspondence table may include different data IDs associated with the same flow ID. Thus, it is possible to suppress an increase in the data amount of the table data due to correspondence of the same flow information to different data IDs.

(3) The destination may include belonging information indicating the belonging of the device including the arithmetic circuit, and device information indicating the device including the arithmetic circuit. When the arithmetic circuit is a virtual arithmetic part, the device information may be information for specifying the arithmetic circuit provided with the virtual arithmetic part. With such a configuration, the position of the arithmetic circuit or the like can be specified by looking at the destination.

(4) The generating unit may transmit the generated table data to an electronic computer including at least one of the plurality of arithmetic circuits.

(C) The electronic computer may include at least one of a plurality of arithmetic circuits that sequentially execute a plurality of processings on processing data to be processed. At least one of the plurality of arithmetic circuits may receive the processing data together with the data ID for identifying the processing data and the sequence number indicating to which processing of a plurality of processings has been executed. The above-mentioned one arithmetic circuit may increment the sequence number, when the processing data is processed. The one may refer to the table data (refer to (B)) in which the data ID and flow information are associated with each other, and acquire a destination corresponding to the incremented sequence number among destinations included in the flow information corresponding to the data ID. In the above-mentioned one arithmetic circuit, the processing result of itself may be transmitted to the arithmetic circuit of the acquired destination. The next destination is preferably specified by the sequence number.

### Scope of Present Invention

The present invention is not limited to the foregoing embodiments and modified examples. For example, the present invention includes various changes to the above embodiments and modification example that can be understood by those skilled in the art within the scope of the technical idea of the present invention. The structures described in the above-mentioned embodiments and the modification example can be appropriately combined within a range without contradiction. Further, any of the above-mentioned configurations can be deleted.

### REFERENCE SIGNS LIST

1 Data generating device
10 Electronic computer
20 Control unit
30 Storage unit
31 Main storage device
32 Auxiliary storage device
40 Arithmetic part
41 Arithmetic circuit
42 Transmission circuit
43 Transmission circuit
50 Communication line
60 Communication line
110 Electronic computer
210 Electronic computer
410 Electronic computer
510 Electronic computer
610 Electronic computer
710 Electronic computer

1-9. (canceled)

10. An electronic computer comprising:
a plurality of arithmetic circuits configured to sequentially execute a plurality of processings on a processing data; and
a controller configured to execute a program and perform a control of causing the plurality of arithmetic circuits to sequentially execute the plurality of processings, wherein an arithmetic circuit ID is imparted to each of the plurality of arithmetic circuits, the plurality of arithmetic circuits include a first arithmetic circuit configured to execute a first processing among the plurality of processings, and a second arithmetic circuit configured to execute a second processing that executes processing on a processing result of the first processing among the plurality of processings, and
the first arithmetic circuit configured to transmit the processing result of the first processing to the arithmetic circuit ID of the second arithmetic circuit as a destination.

11. The electronic computer according to claim 10, further comprising:
a main storage device of the controller,
wherein the processing result of the first processing is transmitted to the second arithmetic circuit without passing through the main storage device.

12. The electronic computer according to claim 10, further comprising:
a plurality of first transmission circuits connected to each of the plurality of arithmetic circuits; and
a first communication line to which the plurality of first transmission circuits and the controller are connected,
wherein the plurality of first transmission circuits include a first-1 transmission circuit connected to the first arithmetic circuit, and a first-2 transmission circuit connected to the second arithmetic circuit,
the first-1 transmission circuit configured to transmit the processing result of the first processing to the first communication line together with the arithmetic circuit ID of the second arithmetic circuit, and
the first-2 transmission circuit configured to receive the processing result of the first processing transmitted together with the arithmetic circuit ID of the second arithmetic device from the first communication line, and transmit the received processing result to the second arithmetic circuit.

13. The electronic computer according to claim 12,
wherein the plurality of arithmetic circuits include a third arithmetic circuit configured to execute third processing of performing processing on a processing result of the second processing among the plurality of processings,
the plurality of first transmission circuits include a first-3 transmission circuit connected to the third arithmetic circuit,
the first-2 transmission circuit configured to transmit the processing result of the second processing to the first communication line together with the arithmetic circuit ID of the third arithmetic circuit,
the first-3 transmission circuit configured to receive the processing result of the second processing transmitted together with the arithmetic circuit ID of the third arithmetic device from the first communication line, and transmit the received processing result to the third arithmetic circuit, and
the arithmetic circuit ID of the second arithmetic circuit and the arithmetic circuit ID of the third arithmetic circuit are imparted to the processing result of the first processing from a stage of being transmitted from the first-1 transmission circuit to the first communication line.

14. The electronic computer according to claim 12, further comprising:
a second transmission circuit connected to the second arithmetic circuit and connected to a second communication line,
wherein a first circuit ID that is the arithmetic circuit ID and a second circuit ID different from the first circuit ID are imparted to the second arithmetic circuit,
the second arithmetic circuit is configured such that data to be processed by the second processing is input together with the first circuit ID from the first communication line via the first-2 transmission circuit or input together with the second circuit ID from the second communication line via the second transmission circuit, and
the second arithmetic circuit configured to transmit data obtained by executing the second processing on the data to be processed to the first communication line via the first-2 transmission circuit when the first circuit ID is input, and the second arithmetic circuit configured to transmit the data to the second communication line via the second transmission circuit when the second circuit ID is input.

15. The electronic computer according to claim 10, wherein the second arithmetic circuit is configured to execute a plurality of types of processing including the second processing, data capable of specifying processing to be executed by the second arithmetic circuit is imparted to the processing result, and the second arithmetic circuit configured to execute processing specified on the basis of data imparted to the processing result, on the processing result.

16. The electronic computer according to claim 15, wherein the second arithmetic circuit is configured to specifity processing to be executed, by referring to a table on the basis of the data.

17. The electronic computer according to claim 16, wherein the data includes data which specifies a branch of processing or parallel execution of a plurality of processings.

18. The electronic computer according to claim 10, wherein when processing requests of the first processing on a first processing target data and the first processing on a second processing target data is compete, the first arithmetic circuit is configured to preferentially execute one of both first processing according to a predetermined priority.
